(19) United States
(12) Patent Application Publication
(10) Pub. No.: US 2021/0038449 A1
(43) Pub. Date: Feb. 11, 2021

(54) VEHICLE

(71) Applicant: Toyota Jidosha Kabushiki Kaisha, Toyota-shi Aichi-ken (JP)

(72) Inventors: Osamu Fukawatase, Miyoshi-shi (JP); Fumiko Nakai, Anjo-shi (JP)

(73) Assignee: Toyota Jidosha Kabushiki Kaisha, Toyota-shi Aichi-ken (JP)

(21) Appl. No.: 16/930,007

(22) Filed: Jul. 15, 2020

(30) Foreign Application Priority Data
Aug. 7, 2019 (JP) 2019-145440

(51) Int. Cl. A61G 3/08

(52) U.S. Cl. CPC A61G 3/0808

(57) ABSTRACT

A vehicle includes: a standing wall portion that is provided in a standing manner on a vehicle cabin floor and extends in a vehicle width direction; a side wall portion extending in a vehicle front-rear direction, at least one end portion of the standing wall portion being connected to the side wall portion; a first fastening belt including one end portion fixed to the standing wall portion and another end portion to be fixed to a wheelchair with a wheel in contact with at least one of the standing wall portion and the side wall portion; and a second fastening belt including one end portion fixed to the side wall portion and another end portion to be fixed to the wheelchair with the wheel in contact with at least one of the standing wall portion and the side wall portion.

### CROSS-REFERENCE TO RELATED APPLICATIONS

This application claims priority to Japanese Patent Application No. 2019-145440 filed on Aug. 7, 2019, which is incorporated herein by reference in its entirety including the specification, drawings and abstract.

### BACKGROUND

### 1. Technical Field

The disclosure relates to a vehicle.

### 2. Description of Related Art

Japanese Patent Application Publication No. 1-136657 (JP 1-136657 A) discloses a structure in which a pair of right and left belts stored under the floor of a vehicle are withdrawn and fixed to frames on the front side of a wheelchair and frames on the rear side of the wheelchair are fixed via fastening belts stored under the floor of the vehicle. Also, Japanese Patent Application Publication No. 8-89532 (JP 8-89532 A) discloses a fixing device that fixes (fastens) a wheelchair to the inside of a vehicle cabin via a pair of belt-type binding means provided at a rear wall (standing wall).

### SUMMARY

However, the technique described in JP 1-136657 A requires a mechanism that stores the fastening belts, etc., under the floor of the vehicle, which makes work for fastening a wheelchair complicated. On the other hand, in the technique described in JP 8-89532 A, a wheelchair is fastened by the pair of belt-type binding means provided at the rear wall, which may result in failure to sufficiently curb horizontal wobbling of the wheelchair.

In view of the above fact, an object of the disclosure is to provide a vehicle that enables upward, downward, rightward and leftward wobbling of a wheelchair to be curbed with a simple structure.

The vehicle according to a first aspect includes: a standing wall portion that is provided in a standing manner on a vehicle cabin floor and extends in a vehicle width direction; a side wall portion extending in a vehicle front-rear direction from the standing wall portion; a first fastening belt including one end portion fixed to the standing wall portion and the other end portion to be fixed to a wheelchair with a wheel in contact with at least one of the standing wall portion and the side wall portion; and a second fastening belt including one end portion fixed to the side wall portion and the other end portion to be fixed to the wheelchair with the wheel in contact with at least one of the standing wall portion and the side wall portion.

In the vehicle according to the first aspect, the one end portion of the first fastening belt is fixed to the standing wall portion that is provided in a standing manner on the vehicle cabin floor and extends in a vehicle width direction and the other end portion of the first fastening belt is fixed to a wheelchair. Also, the one end portion of the second fastening belt is fixed to the side wall portion extending in the vehicle front-rear direction and the other end portion of the second fastening belt is fixed to the wheelchair. Then, the first fastening belt and the second fastening belt are fixed to the wheelchair with a wheel in contact with at least one of the standing wall portion and the side wall portion. In other words, a wheelchair can be fixed to the standing wall portion and the side wall portion by the first fastening belt and the second fastening belt in a state in which rotation of wheels of the wheelchair are curbed, enabling curbing of forward, rearward, rightward and leftward wobbling of the wheelchair.

Also, since a wheelchair is fastened with a wheel in contact with at least one of the standing wall portion and the side wall portion, the wheelchair can be fastened by two fastening belts, the first fastening belt and the second fastening belt, alone, enabling achievement of a simple structure.

The vehicle according to a second aspect is the vehicle according to the first aspect, in which: when the first fastening belt is fixed to the wheelchair, the first fastening belt may obliquely extend further to the outer side in the vehicle width direction as the first fastening belt extends further in the vehicle front-rear direction from the standing wall portion; and when the second fastening belt is fixed to the wheelchair, the second fastening belt may obliquely extend further to the inner side in the vehicle width direction as the second fastening belt extends further in the vehicle front-rear direction from the side wall portion.

In the vehicle according to the second aspect, a wheelchair is fastened by the first fastening belt and the second fastening belt that extend obliquely. Consequently, a wheelchair can be fastened in an area surrounded by the standing wall portion, the side wall portion, the first fastening belt and the second fastening belt, enabling curbing of overturning of the wheelchair.

The vehicle according to a third aspect is the vehicle according to the first aspect or second aspect, in which: a fixation portion of the first fastening belt, the fixation portion being fixed to the standing wall portion, may be located on the inner side in the vehicle width direction relative to the wheelchair in a fastened state; and a fixation portion of the second fastening belt, the fixation portion being fixed to the side wall portion, may be more distant from the standing wall portion than the wheelchair in a fastened state.

In the vehicle according to the third aspect, the fixation portion of the first fastening belt, the fixation portion being fixed to the standing wall portion, is disposed on the inner side in the vehicle width direction relative to a wheelchair, enabling tension acting obliquely toward the standing wall portion and to the vehicle inner side in the vehicle width direction to be applied to a wheelchair. Also, the fixation portion of the second fastening belt, the fixation portion being fixed to the side wall portion, is more distant from the standing wall portion than the wheelchair, enabling an increase in tension in the vehicle front-rear direction, the tension applied to the wheelchair, in comparison with a case where the fixation portion is located at a position at which the fixation portion overlaps the wheelchair in the vehicle width direction.

The vehicle according to a fourth aspect is the vehicle according to any one of the first aspect to the third aspect, in which a hook that is engageable with a frame of the wheelchair may be provided at each of the other end portion of the first fastening belt and the other end portion of the second fastening belt.

In the vehicle according to the fourth aspect, a wheelchair can be fastened merely by engaging (putting) the hook of the first fastening belt and the hook of the second fastening belt on (with) respective frames of the wheelchair.

The vehicle according to a fifth aspect is the vehicle according to any one of the first aspect to the fourth aspect, in which the one end portion of the first fastening belt may be withdrawably wound on a first retractor and the one end portion of the second fastening belt may be withdrawably wound on a second retractor.

In the vehicle according to the fifth aspect, when no wheelchair is fastened, the first fastening belt is wound on the first retractor and the second fastening belt is wound on the second retractor. Consequently, the first fastening belt and the second fastening belt becoming an encumbrance to another passenger can be curbed.

The vehicle according to a sixth aspect is the vehicle according to any one of the first aspect to the fifth aspect, in which the other end portion of the first fastening belt may be fixed to one frame of the wheelchair with a pair of right and left rear wheels in contact with the standing wall portion; and the other end portion of the second fastening belt may be fixed to another frame of the wheelchair with the pair of right and left rear wheels in contact with the standing wall portion.

In the vehicle according to the sixth aspect, as a result of a wheelchair being fastened with the pair of right and left rear wheels of the wheelchair in contact with the standing wall portion, rotation of wheels of the wheelchair can more reliably be curved in comparison with a case where only one wheel of a wheelchair is in contact with the standing wall portion or the side wall portion.

The vehicle according to a seventh aspect includes: a standing wall portion that is provided in a standing manner on a vehicle cabin floor and extends in a vehicle width direction; a side wall portion extending in a vehicle front-rear direction from the standing wall portion; a first binding belt including one end portion fixed to one of the standing wall portion and the side wall portion and the other end portion provided with a buckle; and a second binding belt including one end portion fixed to the other of the standing wall portion and the side wall portion, and the other end portion provided with a tongue plate that is engageable with the buckle, upon the tongue plate being engaged with the buckle, the second binding belt binding a passenger seated in a wheelchair with a wheel in contact with at least one of the standing wall portion and the side wall portion.

In the vehicle according to the seventh aspect, the one end portion of the first binding belt is fixed to one of the standing wall portion and the side wall portion and the buckle is provided at the other end portion of the first binding belt. Also, the one end portion of the second binding belt is fixed to the other of the standing wall portion and the side wall portion and a tongue plate that is engageable with the buckle is provided at the other end portion of the second binding belt. Then, a passenger seated in a wheelchair can be bound with a simple structure in which the tongue plate is engaged with the buckle.

Also, a passenger is bound with a wheel in contact with at least one of the standing wall portion and the side wall portion, the wheel are prevented from rotating, and thus, forward, rearward, rightward and leftward wobbling of the wheelchair can be curbed.

The vehicle according to an eighth aspect is the vehicle according to the seventh aspect, in which: the one end portion of the second binding belt is withdrawably wound on a retractor for a passenger; and the retractor for a passenger is configured to be electrically switchable between a locked state in which the second binding belt is unwithdrawable and an unlocked state in which the second binding belt is withdrawable.

In the vehicle according to the eighth aspect, the retractor for a passenger is configured to be electrically switchable between the locked state and the unlocked state. Consequently, for example, even where a general emergency locking function does not work such as a case of sudden braking when a passenger rides in a low-speed autonomous vehicle, the second binding belt can reliably be locked so as to prevent withdrawal of the second binding belt.

The vehicle according to a ninth is the vehicle according to the seventh aspect or the eighth aspect, in which: when the first binding belt binds the passenger in the wheelchair, the first binding belt may obliquely extend further to the outer side in the vehicle width direction as the first binding belt extends further in the vehicle front-rear direction from the standing wall portion; and when the second binding belt binds the passenger in the wheelchair, the second binding belt may obliquely extend further to the inner side in the vehicle width direction as the second binding belt extends further in the vehicle front-rear direction from the side wall portion.

In the vehicle according to the ninth aspect, a passenger is bound by the first binding belt and the second binding belt that extend obliquely. Consequently, a wheelchair can be fastened in an area surrounded by the standing wall portion, the side wall portion, the first binding belt and the second binding belt, enabling curbing of overturning of the wheelchair.

The vehicle according to a tenth aspect is the vehicle according to any one of the seventh aspect to the ninth aspect, in which the tongue plate may be configured to be engaged with the buckle in a state in which the passenger of the wheelchair with a pair of right and left rear wheels in contact with the standing wall portion is bound by the first binding belt and the second binding belt.

In the vehicle according to the tenth aspect, as a result of a passenger being bound with a pair of right and left rear wheels of a wheelchair in contact with the standing wall portion, rotation of wheels of the wheelchair can more reliably be curbed in comparison with a case where a passenger is bound with only one wheel of a wheelchair in contact with the standing wall portion or the side wall portion.

As described above, the vehicles according to the first aspect and the seventh aspect enable forward, rearward, rightward and leftward wobbling of a wheelchair to be curbed with a simple structure.

The vehicle according to the second aspect enables overturning of a wheelchair to be curbed with a simple structure.

The vehicle according to the third aspect enables a fastened state of a wheelchair to be favorably maintained.

The vehicle according to the fourth aspect enables a wheelchair to be fastened with a simple structure using the first fastening belt and the second fastening belt.

The vehicle according to the fifth aspect enables enhancement in convenience.

The vehicle according to the sixth aspect enables a fastened state of a wheelchair to be more favorably maintained in comparison with a case where a wheelchair is fastened with only one wheel of the wheelchair in contact with the standing wall portion or the side wall portion.

The vehicle according to the eighth aspect enables a bound state of a passenger to be favorably maintained.

The vehicle according to the ninth aspect enables overturning of a wheelchair to be curbed with a simple structure.

The vehicle according to the tenth aspect enables further enhancement in capability of binding a passenger in comparison with a case where a passenger is bound with only one of wheels of a wheelchair in contact with the standing wall portion or the side wall portion.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram of the inside of a cabin of a vehicle according to a first embodiment as viewed from the vehicle rear side;

FIG. 2 is a plan view of the inside of the cabin of the vehicle according to the first embodiment from the vehicle upper side;

FIG. 3 is a plan view illustrating a first alteration of the vehicle according to the first embodiment and corresponding to FIG. 2;

FIG. 4 is a plan view illustrating a second alteration of the vehicle according to the first embodiment and corresponding to FIG. 2;

FIG. 5 is a plan view illustrating a third alteration of the vehicle according to the first embodiment and corresponding to FIG. 2;

FIG. 6 is a plan view of the inside of a cabin of a vehicle according to a second embodiment from the vehicle upper side;

FIG. 7 is a plan view illustrating a first alteration of the vehicle according to the second embodiment and corresponding to FIG. 6;

FIG. 8 is a plan view illustrating a second alteration of the vehicle according to the second embodiment and corresponding to FIG. 6; and

FIG. 9 is a plan view illustrating another example of a vehicle according to the disclosure and corresponding to FIG. 2.

### DETAILED DESCRIPTION OF EMBODIMENTS

### First Embodiment

A vehicle 10 according to a first embodiment will be described with reference to the drawings. Note that arrow FR, arrow UP and arrow RH in the drawings indicate a vehicle travel direction (vehicle front side), the vehicle upper side and the vehicle right side of the vehicle, respectively. Where front, rear, right, left, up (upper) and down (lower) directions are used in the description, the front, rear, right, left, up (upper) and down (lower) directions denote the front and the rear in a vehicle front-rear direction, the right and the left when the vehicle faces the travel direction and up (upper) and down (lower) in a vehicle height direction unless otherwise specifically noted. Also, the description will be provided on the assumption that the right and the left of a wheelchair 100 is the right and the left as viewed from a passenger P seated in the wheelchair 100.

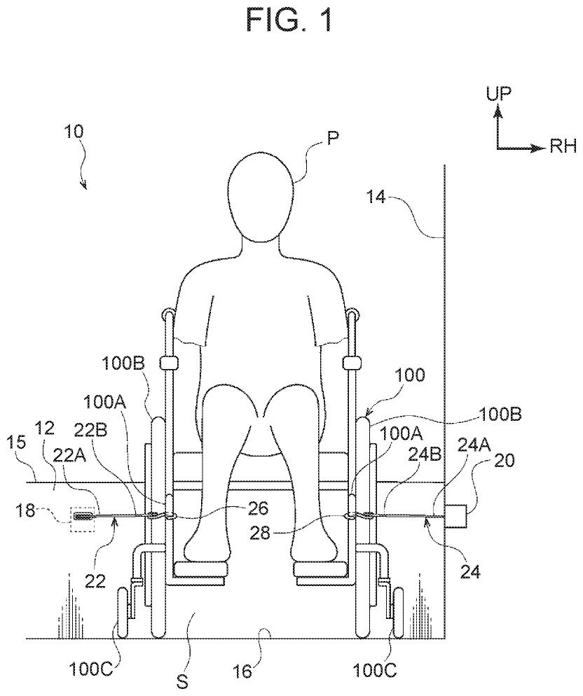

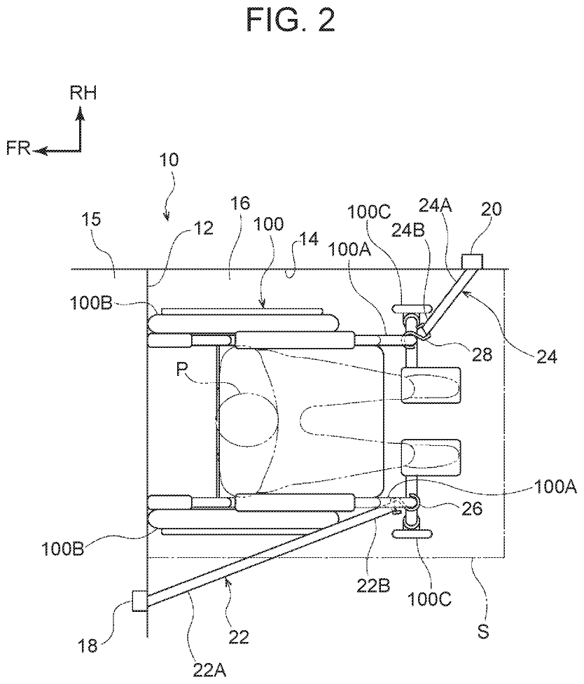

As illustrated in FIGS. 1 and 2, in the vehicle 10 according to the present embodiment, a fastening space S for fastening a wheelchair 100 is set, and a standing wall portion 12 is provided on the vehicle front side of the fastening space S. The present embodiment will be described in terms of a case where the wheelchair 100 is fastened to the fastening space S of the vehicle 10 so as to face rearward.

The standing wall portion 12 is provided in a standing manner on a floor panel 16, extends in a vehicle height direction and a vehicle width direction and extends toward the vehicle upper side to be slightly lower than a height of rear wheels 100B of the wheelchair 100. Also, a substantially-planar top surface 15 extends from an upper end portion of the standing wall portion 12 toward the vehicle front side and the top surface 15 forms, for example, a seating surface of a normal seat. Also, at least one end portion of the standing wall portion 12 is connected to a side wall portion 14, and in the present embodiment, an end portion on the vehicle right side of the standing wall portion 12 is connected to the side wall portion 14.

Like the standing wall portion 12, the side wall portion 14 is provided in a standing manner on the floor panel 16 and extends in the vehicle height direction and the vehicle front-rear direction. Then, a right wall surface of a vehicle cabin is formed by the side wall portion 14.

Here, a first retractor 18 is provided in the standing wall portion 12 and one end portion 22A of a first fastening belt 22 withdrawably wound on the first retractor 18. Like a seat belt for passenger binding, the first fastening belt 22 is formed of a substantially strip-shaped fabric material, a first hook 26 is provided at another end portion 22B of the first fastening belt 22. Then, the first hook 26 is formed in a substantially S-shape and is configured to be engageable with a right-side frame 100A of the wheelchair 100.

Note that in a state illustrated in FIGS. 1 and 2, the other end portion 22B of the first fastening belt 22 is withdrawn from the first retractor 18 and the first hook 26 is put on (engaged with) the right-side frame 100A of the wheelchair 100. Consequently, the other end portion 22B of the first fastening belt 22 is fixed to the wheelchair 100.

Also, as illustrated in FIG. 2, when the first fastening belt 22 is fixed to the wheelchair 100, the first fastening belt 22 obliquely extends further to the vehicle right side (that is, the outer side in the vehicle width direction) as the first fastening belt 22 extends further from the standing wall portion 12 toward the vehicle rear side. Furthermore, a position of the first retractor 18, which is a fixation of the first fastening belt 22, the fixation portion being fixed to the standing wall portion 12, is located on the inner side in the vehicle width direction relative to the wheelchair 100 in a fastened state.

On the other hand, a second retractor 20 is provided in the side wall portion 14 and one end portion 24A of a second fastening belt 24 is withdrawably wounded on the second retractor 20. Like the first fastening belt 22, the second fastening belt 24 is formed of a substantially strip-shaped fabric material, and a second hook 28 is provided at another end portion 24B of the second fastening belt 24. Then, the second hook 28 is formed in a substantially S-shape and configured to be engageable with a left-side frame 100A of the wheelchair 100.

Note that in the state illustrated in FIGS. 1 and 2, the other end portion 24B of the second fastening belt 24 is withdrawn from the second retractor 20 and the second hook 28 is put on (engaged with) the left-side frame 100A of the wheelchair 100.

Consequently, the other end portion 24B of the second fastening belt 24 is fixed to the wheelchair 100.

Also, as illustrated in FIG. 2, when the second fastening belt 24 is fixed to the wheelchair 100, the second fastening belt 24 obliquely extends further to the vehicle left side (that is, the inner side in the vehicle width direction) as the second fastening belt 24 extends further from a part, on the vehicle rear side relative to a front wheel 100C, of the side wall portion 14 toward the vehicle front side. In other words, like the first fastening belt 22, the second fastening belt 24 obliquely extends further to the vehicle right side as the second fastening belt 24 extends further from the vehicle front side toward the vehicle rear side.

Furthermore, a position of the second retractor 20, which is a fixation portion of the second fastening belt, the fixation portion being fixed to the side wall portion 14, is located on the vehicle rear side relative to the wheelchair 100 in a fastened state in a direction away from the standing wall portion 12.

Here, a wheel (a rear wheel 100B or a front wheel 100C) of the wheelchair 100 is in contact with at least one of the standing wall portion 12 and the side wall portion 14, and in such state, the other end portion 22B of the first fastening belt 22 and the other end portion 24B of the second fastening belt 24 are fixed to the wheelchair 100. In the present embodiment, as an example, the pair of right and left rear wheels 100B of the wheelchair 100 are in contact with the standing wall portion 12, and in such state, the other end portion 22B (first hook 26) of the first fastening belt 22 is fixed to the right-side frame 100A of the wheelchair 100. Also, the other end portion 24B (second hook 28) of the second fastening belt 24 is fixed to the left-side frame 100A of the wheelchair 100 with the pair of right and left rear wheels 100B of the wheelchair 100 in contact with the standing wall portion 12.

Operation

Next, operation of the present embodiment will be described.

As described above, in the vehicle 10 according to the present embodiment, the one end portion 22A of the first fastening belt 22 is fixed to the standing wall portion 12 provided in a standing manner on the floor panel 16, and the other end portion 22B of the first fastening belt 22 is fixed to the wheelchair 100. Also, the one end portion 24A of the second fastening belt 24 is fixed to the side wall portion and the other end portion 24B of the second fastening belt 24 is fixed to the wheelchair 100. Then, the first fastening belt 22 and the second fastening belt 24 are fixed to the wheelchair 100 with the pair of right and left rear wheels 100B in contact with the standing wall portion 12. In other words, the wheelchair 100 can be fixed to the standing wall portion 12 and the side wall portion 14 by the first fastening belt 22 and the second fastening belt 24 in a state in which rotation of the pair of right and left rear wheels 100B is curbed, enabling curbing of forward, rearward, rightward and leftward wobbling of the wheelchair 100.

Also, since the wheelchair 100 is fastened with the pair of right and left rear wheels 100B in contact with the standing wall portion 12, the wheelchair 100 can be fastened by two fastening belts, the first fastening belt 22 and the second fastening belt 24, alone, enabling achievement of a simple structure. In other words, forward, rearward, rightward and leftward wobbling of the wheelchair 100 can be curbed with a simple structure.

Furthermore, in the present embodiment, the wheelchair 100 is fastened by the first fastening belt 22 and the second fastening belt 24 that extend obliquely. Consequently, the wheelchair 100 can be fastened in an area surrounded by the standing wall portion 12, the side wall portion 14, the first fastening belt 22 and the second fastening belt 24, enabling curbing of overturning of the wheelchair 100. As a result, overturning of the wheelchair 100 can be curbed with a simple structure.

Furthermore, in the present embodiment, the fixation portion of the first fastening belt 22, the fixation portion being fixed to the standing wall portion 12, is disposed on the inner side relative to the wheelchair 100 in the vehicle width direction, enabling tension acting obliquely to the vehicle front side and the vehicle left side to be applied to the wheelchair 100. On the other hand, a fixation portion of the second fastening belt 24, the fixation being fixed to the side wall portion 14, is disposed on the vehicle rear side relative to the wheelchair 100, tension applied to the wheelchair 100, the tension acting to the vehicle rear side, can be increased. In this way, the fastened state of the wheelchair 100 can favorably be maintained.

Also, in the present embodiment, the wheelchair 100 can be fastened merely by putting the first hook 26 of the first fastening belt 22 and the second hook 28 of the second fastening belt 24 on the right and left frames 100A of the wheelchair 100. In other words, the wheelchair 100 can be fastened with a simple structure using the first fastening belt 22 and the second fastening belt 24.

Furthermore, in the present embodiment, when no wheelchair 100 is fastened, the first fastening belt 22 is wound on the first retractor 18 and the second fastening belt 24 is wound on the second retractor 20. Consequently, the first fastening belt 22 and the second fastening belt 24 becoming an encumbrance to another passenger P can be curbed, enabling enhancement in convenience.

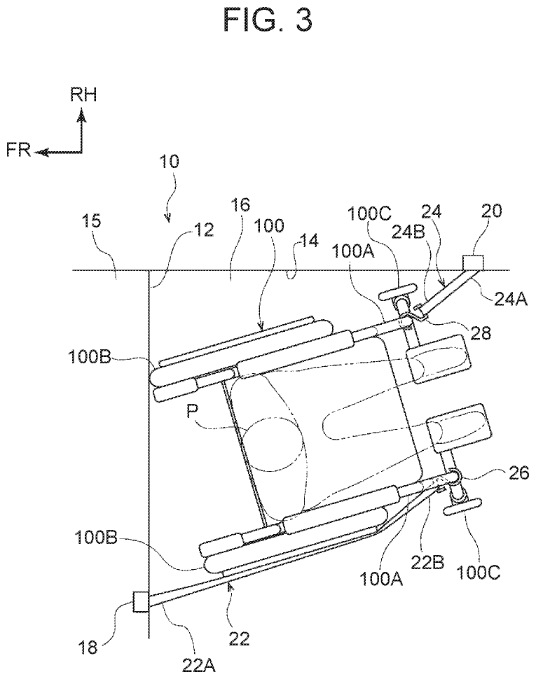

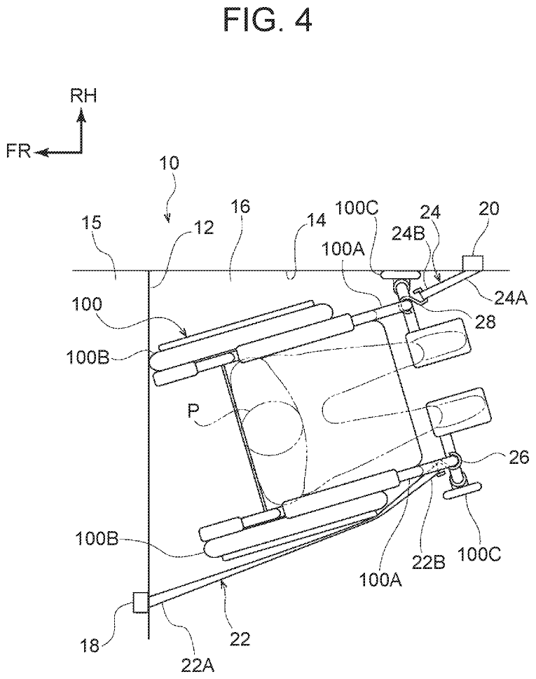

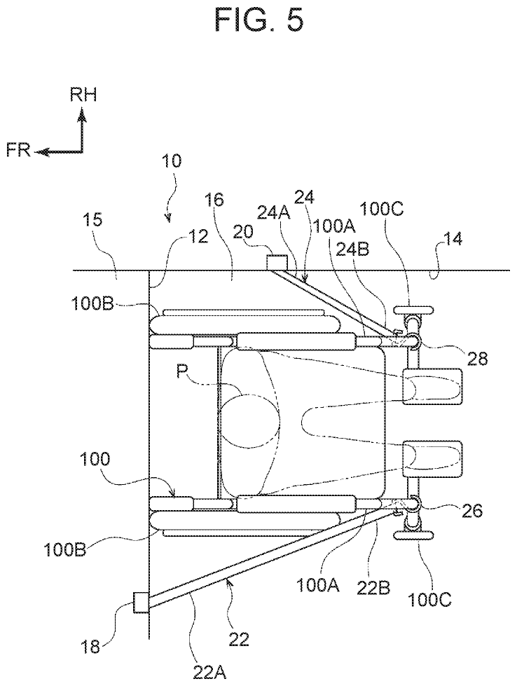

Note that although in the present embodiment, the wheelchair 100 is fastened with the pair of right and left rear wheels 100B of the wheelchair 100 in contact with the standing wall portion 12, the disclosure is not limited to this case. For example, a wheelchair 100 may be fastened as in first and second alterations, which are illustrated in FIGS. 3 and 4, respectively. Also, as in a third alteration, which is illustrated in FIG. 5, a position of the second retractor 20 may be changed.

### First Alteration of First Embodiment

As illustrated in FIG. 3, in a first alteration, a wheelchair 100 is fastened in a state in which the wheelchair 100 is disposed obliquely relative to a vehicle front-rear direction. Then, the wheelchair 100 is fastened with a left-side rear wheel 100B in contact with a standing wall portion 12.

More specifically, a first fastening belt 22 includes one end portion 22A withdrawably wound on a first retractor 18 fixed to the standing wall portion 12. Also, another end portion 22B of the first fastening belt 22 is fixed to a right-side frame 100A of the wheelchair 100 via a first hook 26.

A second fastening belt 24 includes one end portion 24A withdrawably wound on a second retractor 20 fixed to a side wall portion 14. Also, another end portion 24B of the second fastening belt 24 is fixed to a left-side frame 100A of the wheelchair 100 via a second hook 28. As described above, in the present alteration, as in the first embodiment, the wheelchair 100 can be fixed to the standing wall portion 12 and the side wall portion 14 by the first fastening belt 22 and the second fastening belt 24 in a state in which rotation of the rear wheel 100B of the wheelchair 100 is curbed, enabling curbing of forward, rearward, rightward and leftward wobbling of the wheelchair 100.

### Second Alteration of First Embodiment

As illustrated in FIG. 4, in a second alteration, a wheelchair 100 is fastened in a state in which the wheelchair 100 is disposed obliquely relative to a vehicle front-rear direction. Then, the wheelchair 100 is fastened with a left-side rear wheel 100B in contact with a standing wall portion 12 and a left-side front wheel 100C in contact with a side wall portion 14.

More specifically, the first fastening belt 22 includes one end portion 22A withdrawably wound on a first retractor 18 fixed to the standing wall portion 12. Also, another end portion 22B of the first fastening belt 22 is fixed to a right-side frame 100A of the wheelchair 100 via a first hook 26.

A second fastening belt 24 includes one end portion 24A withdrawably wound on a second retractor 20 fixed to the side wall portion 14. Also, another end portion 24B of the second fastening belt 24 is fixed to a left-side frame 100A of the wheelchair 100 via a second hook 28. As described above, in the present alteration, the wheelchair 100 can be fixed to the standing wall portion 12 and the side wall portion 14 by the first fastening belt 22 and the second fastening belt 24 in a state in which rotation of rear wheels 100B and front wheels 100C of the wheelchair 100 is curbed, enabling curbing of forward, rearward, rightward and leftward wobbling of the wheelchair 100. Also, the left-side front wheel 100C being brought into contact with the side wall portion 14 enables further stabilization of a fastened state relative to the first alteration.

### Third Alteration of First Embodiment

As illustrated in FIG. 5, in a third alteration, a wheelchair 100 is fastened with a pair of left and right rear wheels 100B in contact with a standing wall portion 12. Also, in the present alteration, in the standing wall portion 12, a first retractor 18 is provided on the vehicle left side (inner side in a vehicle width direction) relative to the wheelchair 100 in the fastened state, and one end portion 22A of a first fastening belt 22 is withdrawably wound on the first retractor 18. The other end portion 22B of the first fastening belt 22 is fixed to a right-side frame 100A of the wheelchair 100 via a first hook 26.

Also, in a side wall portion 14, a second retractor 20 is provided at a position at which the second retractor 20 overlaps the wheelchair 100 in the fastened state in the vehicle width direction. Then, one end portion 24A of a second fastening belt 24 is withdrawably wound on the second retractor 20. Another end portion 24B of the second fastening belt 24 is fixed to a left-side frame 100A of the wheelchair 100 via a second hook 28. Therefore, the second fastening belt 24 obliquely extends further to the inner side in the vehicle width direction as the second fastening belt 24 extends further from the side wall portion 14 toward the vehicle rear side.

In the present alteration, as in the first embodiment, the wheelchair 100 can be fixed to the standing wall portion 12 and the side wall portion 14 by the first fastening belt 22 and the second fastening belt 24 in a state in which rotation of the pair of right and left rear wheels 100B of the wheelchair 100 is curbed, enabling curbing of forward, rearward, rightward and leftward wobbling of the wheelchair 100. Also, since the second fastening belt 24 obliquely extends further to the inner side in the vehicle width direction as the second fastening belt 24 extends further from the side wall portion 14 toward the vehicle rear side, enabling a biasing force of biasing the wheelchair 100 toward the standing wall portion 12 side to be enhanced by the first fastening belt 22 and the second fastening belt 24.

### Second Embodiment

Next, a vehicle 50 according to a second embodiment will be described. Note that components that are similar to those of the first embodiment are provided with reference numerals that are the same as those of the first embodiment and description thereof will appropriately be omitted.

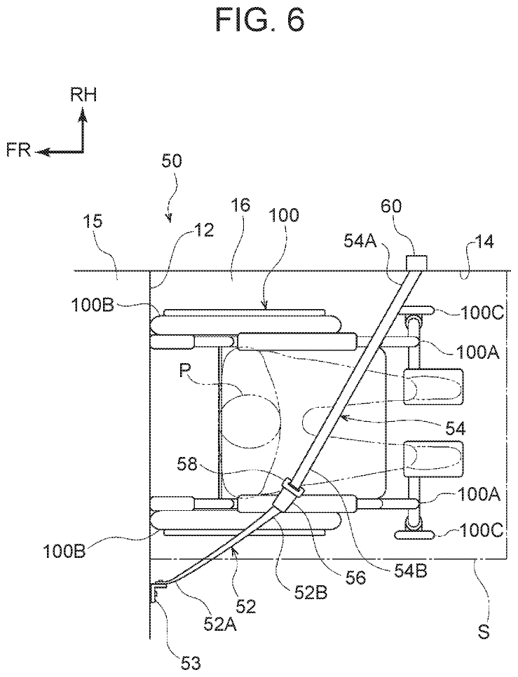

As illustrated in FIG. 6, the present embodiment is different from the first embodiment in that a first binding belt 52 and a second binding belt 54 are provided instead of the first fastening belt 22 and the second fastening belt 24.

More specifically, one end portion 52A of the first binding belt 52 is fixed to a standing wall portion 12 via an anchor member 53. The anchor member 53 is formed in a substantially L-shape in plan view, and a surface of the anchor member 53, the surface extending along the standing wall portion 12, is fixed to the standing wall portion 12. Also, the one end portion 52A of the first binding belt 52 is fixed to a surface of the anchor member 53, the surface extending to the vehicle rear side from the standing wall portion 12. The first binding belt 52 is formed of a substantially strip-shaped fabric material, and a buckle 56 is provided at another end portion 52B of the first binding belt 52.

On the other hand, one end portion 54A of the second binding belt 54 is fixed to a side wall portion 14. More specifically, a retractor 60 for a passenger is provided in the side wall portion 14, and the one end portion 54A of the second binding belt 54 is withdrawably wound on the retractor 60.

The second binding belt 54 is formed by a substantially strip-shaped fabric material, and a tongue plate 58 that is engageable with the buckle 56 is provided at another end portion 54B of the second binding belt 54. Then, in the state in FIG. 6, the second binding belt 54 is withdrawn from the retractor 60 and the tongue plate 58 is engaged with the buckle 56, and as a result of the tongue plate 58 being engaged with the buckle 56, a passenger P seated in a wheelchair 100 is bound.

Here, the retractor 60 is configured to be electrically switchable between a locked state in which the second binding belt 54 is unwithdrawable and an unlocked state in which the second binding belt 54 is withdrawable. In other words, a non-illustrated locking mechanism is provided in the retractor 60, and the retractor 60 is configured to be capable of electrically locking a non-illustrated spool so as to prevent rotation of the spool, by the locking mechanism.

Here, a wheel of the wheelchair 100 is in contact with at least one of the standing wall portion 12 and the side wall portion 14, and in such state, the passenger P is bound by the first binding belt 52 and the second binding belt 54. In the present embodiment, as an example, a pair of right and left rear wheels 100B of the wheelchair 100 are in contact with the standing wall portion 12, and in this state, the passenger P of the wheelchair 100 is bound.

Also, when the first binding belt 52 binds the passenger P of the wheelchair 100, the first binding belt 52 obliquely extends further to the vehicle right side (outer side in a vehicle width direction) as the first binding belt 52 extends further from the standing wall portion 12 toward the vehicle rear side. Furthermore, when the second binding belt 54 binds the passenger P of the wheelchair 100, the second binding belt 54 obliquely extends further to the vehicle left side (inner side in the vehicle width direction) as the second binding belt 54 extends further from the vehicle rear side relative to the rear wheel 100B of the side wall portion 14 toward the vehicle front side.

Operation

Next, operation of the present embodiment will be described.

The vehicle 50 according to the present embodiment enables the passenger P seated in the wheelchair 100 to be bound with a simple structure in which the tongue plate 58 is engaged with the buckle 56. Also, since the passenger P is bound with a pair of right and left rear wheels 100B in contact with the standing wall portion 12, the rear wheels 100B of the wheelchair 100 are prevented from rotating, and thus, forward, rearward, rightward and leftward wobbling of the wheelchair 100 can be curbed. In particular, as a result of the passenger P being bound with the pair of right and left rear wheels 100B of the wheelchair 100 in contact with the standing wall portion 12, rotation of wheels of the wheelchair 100 can more reliably be curbed in comparison with a case where a passenger P is bound with only one wheel of a wheelchair in contact with a standing wall portion or a side wall portion. As a result, capability of binding the passenger P can be enhanced.

Also, in the present embodiment, the retractor 60 is configured to be electrically switchable between a locked state and an unlocked state. Then, upon the tongue plate 58 being engaged with the buckle 56 and the second binding belt 54 being wound by the retractor 60, the retractor 60 is electrically switched to a locked state by the locking mechanism. Consequently, for example, even where a general emergency locking function does not work such as a case of sudden braking when a passenger P of a wheelchair 100 rides in a low-speed autonomous vehicle, the second binding belt 54 can reliably be locked so as to prevent withdrawal of the second binding belt 54. In other words, a bound state of the passenger P can favorably be maintained.

Furthermore, in the present embodiment, the passenger P is bound by the first binding belt 52 and the second binding belt 54 that extend obliquely. Consequently, the wheelchair 100 can be fastened in an area surrounded by the standing wall portion 12, the side wall portion 14, the first binding belt 52 and the second binding belt 54, enabling overturning of the wheelchair 100 to be curbed with a simple structure.

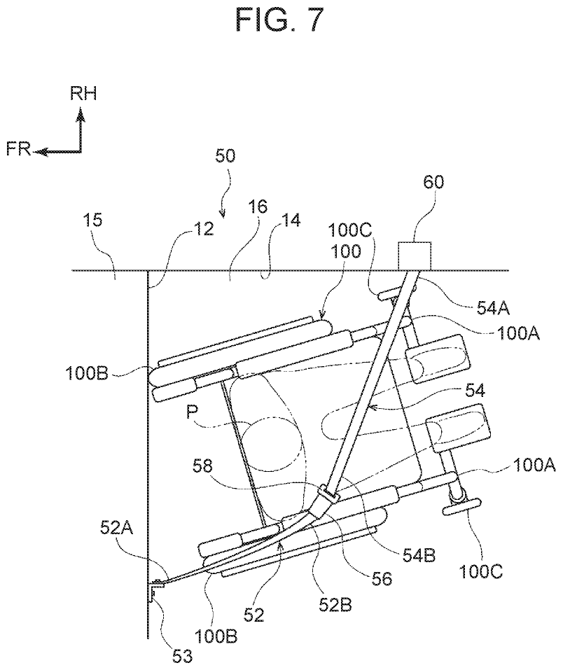

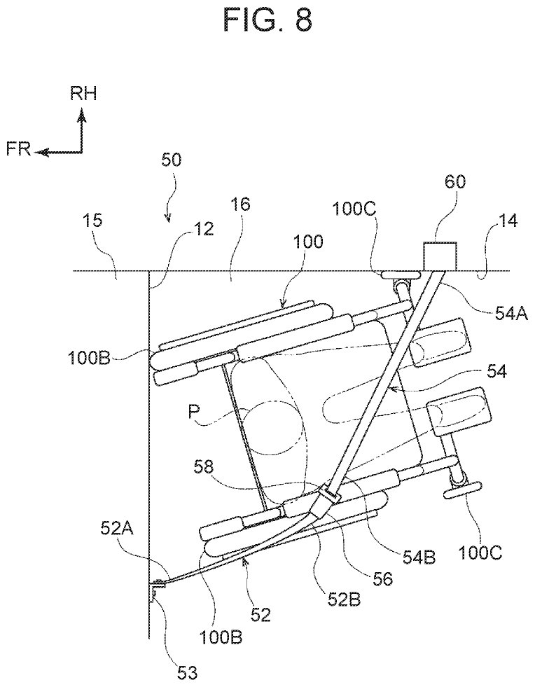

Note that although in the present embodiment, the wheelchair 100 is fastened with the pair of right and left rear wheels 100B of the wheelchair 100 in contact with the standing wall portion 12, the disclosure is not limited to this case. For example, the wheelchair 100 may be fastened as in first and second alterations, which are illustrated in FIGS. 7 and 8.

### First Alteration of Second Embodiment

As illustrated in FIG. 7, in a first alteration, a wheelchair 100 is disposed obliquely relative to a vehicle front-rear direction. Then, in the wheelchair 100, a left-side rear wheel 100B is in contact with a standing wall portion 12.

Also, a first binding belt 52 includes one end portion 52A fixed to the standing wall portion 12 of an anchor member 53. Also, another end portion 52B of the first binding belt 52 extends toward the right side portion of a passenger P.

A second binding belt 54 includes an end portion 54A withdrawably wound on a retractor 60 for a passenger, the retractor 60 being fixed to a side wall portion 14. Also, another end portion 54B of the second binding belt 54 extends toward a buckle 56, and upon a tongue plate 58 being engaged with the buckle 56, the passenger P seated in the wheelchair 100 is bound.

As described above, in the present alteration, as in the second embodiment, the passenger P is bound in a state in which rotation of rear wheels 100B of the wheelchair 100 is curbed, enabling curbing of forward, rearward, rightward and leftward wobbling of the wheelchair 100 with a simple structure.

### Second Alteration of Second Embodiment

As illustrated in FIG. 8, in a second alteration, a wheelchair 100 is fastened in a state in which the wheelchair 100 is disposed obliquely relative to a vehicle front-rear direction. Then, the wheelchair 100 is fastened with a left-side rear wheel 100B in contact with a standing wall portion 12 and a left-side front wheel 100C in contact with a side wall portion 14.

More specifically, a first binding belt 52 includes one end portion 52A fixed to the standing wall portion 12 via an anchor member 53. Also, another end portion 52B of the first binding belt 52 extends toward the right-side portion of a passenger P.

A second binding belt 54 includes one end portion 54A withdrawably wound on a retractor 60 for a passenger, the retractor 60 being fixed to the side wall portion 14. Also, another end portion 54B of the second binding belt 54 extends toward a buckle 56, and upon a tongue plate 58 is engaged with the buckle 56, the passenger P seated in the wheelchair 100 is bound.

As described above, in the present alteration, as in the second embodiment, the passenger P is bound in a state in which rotation of the rear wheels 100B of the wheelchair 100 is curbed, enabling forward, rearward, rightward and leftward wobbling of the wheelchair 100 to be curbed with a simple structure. Also, the left-side front wheel 100C being in contact with the side wall portion 14 enables further curbing of forward, rearward, rightward and leftward wobbling of the wheelchair 100 in comparison with the first alteration.

Although the vehicles according to the first embodiment, the second embodiment and the respective alterations have been described above, it should be understood that the disclosure can be carried out in various modes without departing from the spirit of the disclosure. For example, in the first embodiment and the alterations thereof, at least one of the rear wheels 100B of the wheelchair 100 in a fastened state is in contact with the standing wall portion 12; however, the disclosure is not limited to this case. In other words, it is only necessary that the wheelchair 100 with a wheel in contact with at least one of the standing wall portion 12 and the side wall portion 14 be fastened by the first fastening belt 22 and the second fastening belt 24. As an example, the wheelchair 100 may be fastened with only the left-side front wheel 100C of the wheelchair 100 in contact with the side wall portion 14. The same applies to the second embodiment, and, for example, the passenger P in the wheelchair 100 may be bound with only the left side front wheel 100C of the wheelchair 100 in contact with the side wall portion 14.

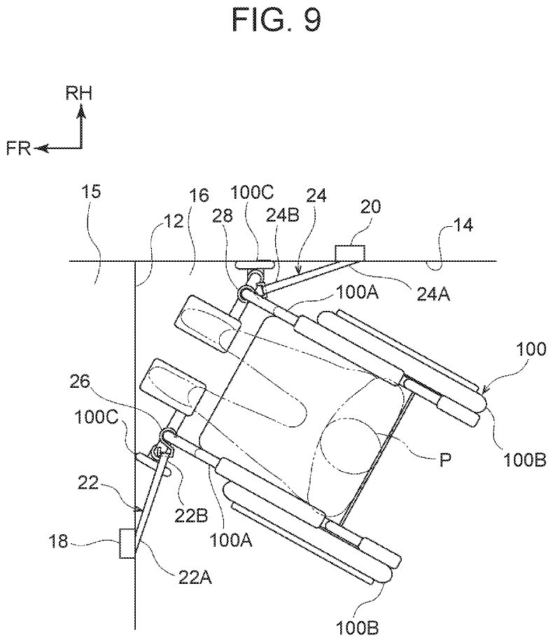

Also, the wheelchair 100 may be fastened by the first fastening belt 22 and the second fastening belt 24 with the rear wheel 100B of the wheelchair 100 in contact with the side wall portion 14. For example, the wheelchair 100 may be disposed with rotated clockwise by 45 degrees from the state in FIG. 2 in plan view to fasten the wheelchair 100 with the left-side rear wheel 100B in contact with the side wall portion 14 and the right-side rear wheel 100B in contact with the standing wall portion 12. Furthermore, as illustrated in FIG. 9, the wheelchair 100 may be fastened with the right-side front wheel 100C in contact with the side wall portion 14 and the left-side front wheel 100C in contact with the standing wall portion 12. In this case, the wheelchair 100 is fastened in a state in which the wheelchair 100 faces the vehicle front side.

Furthermore, although in the first embodiment and the alterations thereof, the one end portion 22A of the first fastening belt 22 is withdrawably wound on the first retractor 18 and the one end portion 24A of the second fastening belt 24 withdrawably wound on the second retractor 20, the disclosure is not limited to this case. For example, neither the first retractor 18 nor the second retractor 20 may be provided by use of, e.g., a stretchable rubber string for each of the first fastening belt 22 and the second fastening belt 24. In this case, at the time of fastening the wheelchair 100, the first fastening belt 22 may be stretched and the first hook 26 may be put on the right-side frame 100A and the second fastening belt 24 may be stretched and the second hook 28 may be put on the left-side frame 100A. In this case, instead of the first hook 26 and the second hook 28, other members such as carabiners may be fixed to the frames 100A of the wheelchair 100.

Furthermore, in the second embodiment and the alterations thereof, control may be performed so that the retractor 60 is unlocked at a predetermined timing. For example, it is possible that: a non-illustrated sensor or the like detects that a wheel of the wheelchair 100 has come in contact with at least one of the standing wall portion 12 and the side wall portion 14, and upon the detection, the retractor 60 is unlocked. In this case, when the wheelchair 100 is in contact with neither the standing wall portion 12 nor the side wall portion 14, the second binding belt 54 cannot be withdrawn and the passenger P thus cannot be bound. In other words, the passenger P can be bound only when a wheel of a wheelchair 100 is in contact with at least one of the standing wall portion 12 and the side wall portion 14, enabling curbing of wrong use.

Also, for example, the second binding belt 54 may be wound by a buckle retractor. In this case, when it is detected that the second binding belt 54 has been wound, the second binding belt 54 may be electrically locked by a locking mechanism.

What is claimed is:

1. A vehicle comprising:
a standing wall portion that is provided in a standing manner on a vehicle cabin floor and extends in a vehicle width direction;
a side wall portion extending in a vehicle front-rear direction from the standing wall portion;
a first fastening belt including one end portion fixed to the standing wall portion and another end portion to be fixed to a wheelchair with a wheel in contact with at least one of the standing wall portion and the side wall portion; and
a second fastening belt including one end portion fixed to the side wall portion and another end portion to be fixed to the wheelchair with the wheel in contact with at least one of the standing wall portion and the side wall portion.

2. The vehicle according to claim 1, wherein:
when the first fastening belt is fixed to the wheelchair, the first fastening belt obliquely extends further to an outer side in the vehicle width direction as the first fastening belt extends further in the vehicle front-rear direction from the standing wall portion; and
when the second fastening belt is fixed to the wheelchair, the second fastening belt obliquely extends further to an inner side in the vehicle width direction as the second fastening belt extends further in the vehicle front-rear direction from the side wall portion.

3. The vehicle according to claim 1, wherein:
a fixation portion of the first fastening belt, the fixation portion being fixed to the standing wall portion, is located on the inner side in the vehicle width direction relative to the wheelchair in a fastened state; and
a fixation portion of the second fastening belt, the fixation portion being fixed to the side wall portion, is more distant from the standing wall portion than the wheelchair in a fastened state.

4. The vehicle according to claim 1, wherein a hook that is engageable with a frame of the wheelchair is provided at each of the other end portion of the first fastening belt and the other end portion of the second fastening belt.

5. The vehicle according to claim 1, wherein the one end portion of the first fastening belt is withdrawably wound on a first retractor and the one end portion of the second fastening belt is withdrawably wound on a second retractor.

6. The vehicle according to claim 1, wherein:
the other end portion of the first fastening belt is fixed to one frame of the wheelchair with a pair of right and left rear wheels in contact with the standing wall portion; and
the other end portion of the second fastening belt is fixed to another frame of the wheelchair with the pair of right and left rear wheels in contact with the standing wall portion.

7. A vehicle comprising:
a standing wall portion that is provided in a standing manner on a vehicle cabin floor and extends in a vehicle width direction;
a side wall portion extending in a vehicle front-rear direction from the standing wall portion;
a first binding belt including one end portion fixed to one of the standing wall portion and the side wall portion and another end portion provided with a buckle; and
a second binding belt including one end portion fixed to the other of the standing wall portion and the side wall portion, and another end portion provided with a tongue plate that is engageable with the buckle, upon the tongue plate being engaged with the buckle, the second binding belt binding a passenger seated in a wheelchair with a wheel in contact with at least one of the standing wall portion and the side wall portion.

8. The vehicle according to claim 7, wherein:
the one end portion of the second binding belt is wound on a retractor for a passenger; and
the retractor for a passenger is configured to be electrically switchable between a locked state in which the second binding belt is unwithdrawable and an unlocked state in which the second binding belt is withdrawable.

9. The vehicle according to claim 7, wherein:
when the first binding belt binds the passenger in the wheelchair, the first binding belt obliquely extends further to an outer side in the vehicle width direction as the first binding belt extends further in the vehicle front-rear direction from the standing wall portion; and
when the second binding belt binds the passenger in the wheelchair, the second binding belt obliquely extends further to an inner side in the vehicle width direction as the second binding belt extends further in the vehicle front-rear direction from the side wall portion.

10. The vehicle according to claim 7, wherein the tongue plate is configured to be engaged with the buckle in a state in which the passenger of the wheelchair with a pair of right and left rear wheels in contact with the standing wall portion is bound by the first binding belt and the second binding belt.
